(19) United States
(12) Patent Application Publication
(10) Pub. No.: US 2017/0264929 A1
(43) Pub. Date: Sep. 14, 2017

(54) VIDEO AND AUDIO TRANSMISSION METHOD AND SYSTEM THEREOF

(71) Applicant: Acrovision Co., Ltd., Seoul (KR)

(72) Inventors: Soo Hong Ahn, Gyeonggi-do (KR); Chang Ki Jin, Gyeonggi-do (KR)

(21) Appl. No.: 15/452,164

(22) Filed: Mar. 7, 2017

(30) Foreign Application Priority Data
Mar. 8, 2016 (KR) 10-2016-0027488

(51) Int. Cl. H04N 21/2343; H04N 21/236; H04L 29/06

(52) U.S. Cl. CPC H04N 21/23439; H04L 65/608; H04L 65/607; H04N 21/23608

(57) ABSTRACT

Disclosed are a method and a system for providing media streaming by interworking heterogeneous network through a mobile communication network. A method for providing media streaming by interworking heterogeneous network may comprises receiving media data corresponding to media stream requested by a media streaming server from media streaming encoders, multiplexing the received media data in a predefined transport stream format, and performing streaming transport of the multiplexed media data to the media streaming server through a mobile communication network and an internet wired network.

### CROSS-REFERENCE TO RELATED APPLICATION(S)

This application claims priority under 35 U.S.C. §119 to Korean Patent Application No. 10-2016-0027488 filed on Mar. 8, 2016, in the Korean Intellectual Property Office (KIPO), the entire contents of which are incorporated herein by reference.

### BACKGROUND

Field

One or more example embodiments relate to technologies for providing clients with videos taken from different forms of heterogeneous network photography device.

This research was supported by a grant(17AUDP-B100343-03) from Architecture & Urban Development Research Program funded by Ministry of Land, Infrastructure and Transport of Korean government.

Description of Related Art

Although such as broadcasting transmitting stations, power stations, substations, forest fire observations, and the like are difficult to be accessed by people and have poor Internet wired network, real-time video monitoring of the critical infrastructures is necessary. Also, traditionally, a video has been monitored in real-time by using high cost microwave communication.

Recently, as rapidly development of personal media broadcasting, influence of BJ (Broadcasting Jokey) who is the subject of personal broadcasting is expanding. However, in the current filming structure shooting in a fixed studio, it is difficult to draw satisfaction of intermediary demand and it is demanded further active broadcasting contents and diversification of video transmission methods for expanding of new class providing broadcast. For example, there is a growing demand for a system that enables viewers who are not on the spot to enjoy a sports game by letting a BJ who tries to broadcast a sports game on the spot transmit the situation on the spot in real-time.

However, there is a practical difficulty in providing a video in a place where the Internet wired network is not constructed. Currently, most of video and audio transmission devices as an embedded board are provided in a form of server. Accordingly, if a monitor (or a user) monitors or watches a video remotely, it is connected to a server in a form of a client and provided in a form of network stream. Likewise, to be provided a video in a form of network stream, a static IP (Internet Protocol) is assigned to the internet wired network or LTE (Long Term Evolution) router equipment or a VPN (Virtual Private Network) is mounted. If the wired network cannot be installed, it is difficult to monitor a video and assigning a static IP which is a limited resource to a router and using it are very inefficient in IP distribution. Furthermore, as there is a limit to the maximum connecting number on performance of the embedded border, there is a difficulty in providing a plurality of monitors with a video.

Therefore, there is a need for a technology to process media data encoded from a video photography device (for example, a video and audio transmission device) of server function installed on site and to retransmit it to a monitor (or a user).

### SUMMARY

Embodiments of the inventive concepts provide a method and a system to provide media stream through a router mounting a function of media retransmission in transmitting a video and audio through 4G (for example, LTE network) which is a mobile communication network.

A method for providing media streaming by interworking heterogeneous network may comprise receiving media data corresponding to media stream requested by a media streaming server from a plurality of media streaming encoders, multiplexing the received media data in a predefined transport stream format, and performing streaming transport of the multiplexed data to the media streaming server through a mobile communication network and an internet wired network.

According to an aspect of an embodiment, the multiplexing may multiplex the media the media data of the different transport stream formats received from the media streaming encoders in an MPEG-TS (Moving Pictures Expert Group transport stream) format and the performing streaming transport may perform streaming transport of the multiplexed MPEG-TS to the media streaming server over UDP (User Datagram Protocol) (UDP/RTP over UDP).

According to another aspect of an embodiment, the receiving media data may comprise transmitting a message requesting to start transmitting of media data corresponding to the media stream to the media streaming encoders as a request to start transmitting of the media stream is received from the media streaming server and receiving a response message for the message requesting to start to transmitting of media data from the media streaming encoders.

According to another aspect of an embodiment, the multiplexing may multiplex the media data received from the media streaming encoder in transport stream format until a message requesting to stop streaming are received from the media streaming server.

According to another aspect of an embodiment, the media streaming server may be configured to re-multiplex media stream of transport stream format based on predetermined streaming type and to transmit the re-multiplexed media stream to at least one of media streaming clients.

According to another of an embodiment, the media stream transmitted from the media streaming encoders may be simultaneously transmitted in stream form of UDP, RTSP (Real-Time Streaming Protocol), FLV (Flash Video), or HTTP (Hypertext Transfer Protocol) to a plurality of media streaming clients that has requested for transmission of the same media stream.

A system for providing media streaming by interworking heterogeneous network may comprise a data transmitting and receiving unit configured to receive media data corresponding to media stream requested by a media streaming server from a plurality of media streaming encoders and a multiplexing unit configured to multiplex the received media data in a predefined transport stream format, and the data transmitting and receiving unit may perform streaming transport of the multiplexed media data to the media streaming server through a mobile communication network and internet wired network.

According to some example embodiments, by processing a video filmed remotely on a router having a function of media retransmission and providing clients with it through 4G (for example, LTE network) which is a mobile communication network, it is possible to use efficiently a static IP which is a limited resource as well as to provide video monitoring in environment where the internet wired network is not constructed.

Further areas of applicability will become apparent from the description provided herein. The description and specific examples in this summary are intended for purposes of illustration only and are not intended to limit the scope of the present disclosure.

### BRIEF DESCRIPTION OF THE FIGURES

Example embodiments will be described in more detail with regard to the figures, wherein like reference numerals refer to like parts throughout the various figures unless otherwise specified, and wherein:

FIG. 1 illustrates an example of a network environment according to at least one example embodiment;

FIG. 2 is a flowchart illustrating a method for providing media streaming according to at least one example embodiment;

FIG. 3 is a block diagram illustrating internal configuration of a system for providing media streaming according to at least one example embodiment;

FIG. 4 illustrates communication flow for media stream transmission between a system for providing media stream and a media stream encoder according to at least one example embodiment;

FIG. 5 illustrates communication flow for media stream transmission between a system for providing media stream and a media stream server according to at least one example embodiment;

FIG. 6 illustrates communication flow for media stream transmission between a media stream server and a media streaming client according to at least one embodiment;

FIG. 7 is a block diagram illustrating a demonstration environment of an embedded media streaming package according to at least one example embodiment;

FIG. 8 illustrates a configuration of a module in accordance with RTSP media player drive between a system for providing media streaming and media streaming server according to at least one example embodiment;

FIG. 9 illustrates a process to request for RTSP connecting to a media streaming server from RTSP media player according to at least one example embodiment;

FIG. 10 illustrates a process to transmit RTP data to a client through a system for providing media streaming and media streaming server according to at least one example embodiment;

FIG. 11 illustrates a configuration expanded the number of client provided media stream according to at least one example embodiment; and

FIG. 12 illustrates a test result playing RTP data received from a media streaming server according to at least one example embodiment.

### DETAILED DESCRIPTION

Hereinafter, example embodiments will be described in detail with reference to the accompanying drawings.

Example embodiments relate to a technology that media data encoded on a video photography device installed a remote place where people are difficult to access such as mountains, broadcasting transmitting stations, substations, power stations, and the like or a user cannot go directly to the site is converted to transport stream format and provided to a client (for example, a user terminal) by interworking a mobile communication network and an internet wired network. Especially, example embodiments relate to a technology to process media data corresponding to a router having a function of media retransmission or an application program, and transmitted video and audio and to retransmit to a client who is a monitor (for example, a smart phone, a PC (Personal Computer), a tablet, and the like).

In this description, a system for providing media streaming may mean a media streaming router. Also, stream may match with RTSP setup message of one stream information (video or audio data) using in session.

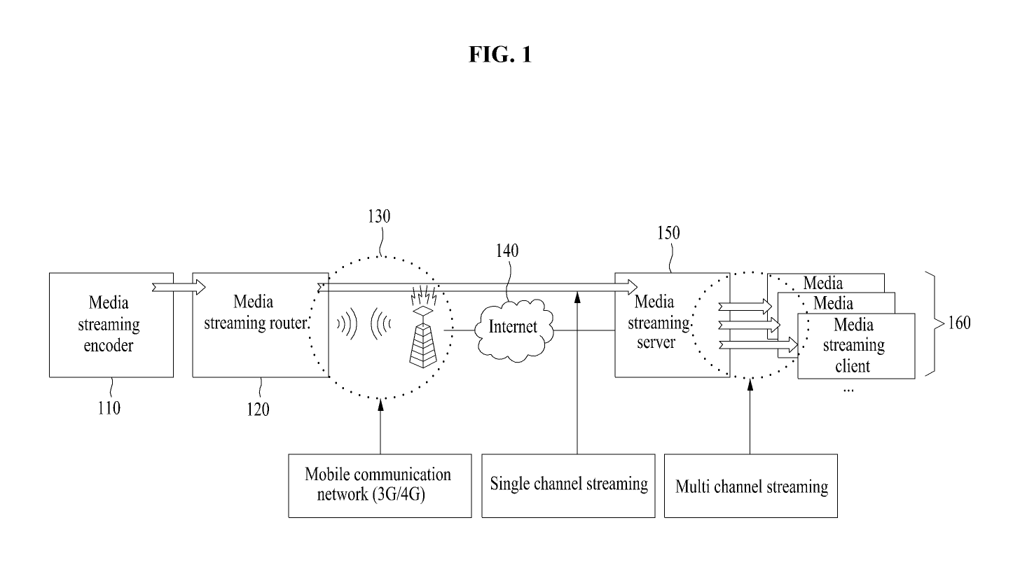

FIG. 1 illustrates an example of a network environment according to at least one example embodiment.

A network environment of FIG. 1 may include a media streaming encoder (110), a media streaming router (120), a mobile communication network (130), an Internet wired network (140), a media streaming server (150), and at least one of media streaming clients (160).

The media streaming encoder (110), as a video photography device following RTSP communication protocol, may be represented as a RTSP media encoder. For example, the media streaming encoder may be installed on the site where a video is to be shot and include a network camera, an IP camera, an action camera, and the like.

The media streaming router (120) may convert media data transmitted to different network stream formats from the media streaming encoder (110) in predefined unified transport stream format and transmit the converted media stream to the media streaming server (150) having a static IP through a mobile communication network (130) such as LTE and the like. For example, as a transport stream format, MPEG-TS may be used.

The mobile communication network (130) is a mobile communication network such as 3G, 4G, and the like constructed by mobile carriers and may represent, for example, 3G and 4G network constructed by mobile carrier SK, 3G and 4G network constructed by mobile carrier KT, and the like.

The media streaming router (120) may transmit media stream to wire and wireless line sharer connected to the internet wired network (140) thought 4G modem connected to a mobile communication network. Then, the line sharer may transmit media stream to the media streaming server (150) connected to local network. In this case, single channel streaming transmission may be performed between the media streaming router (120) and the media streaming server (120). In other words, the media streaming server (150) may receive one media stream in a form of RTP stream from the media streaming encoder (110) through the media streaming router (120).

In addition, the media streaming server (150) may simultaneously provide the received media stream to at least one of clients (160). For example, the media streaming server (150) may provide the corresponding media stream to a client requesting the media stream encoded in the media streaming encoder (110) from among a plurality of media streaming clients. In this case, between the media streaming server (150) and the media streaming clients (160), multi channel streaming transmission may be performed. In other words, the stream provided from the media stream encoder (110) may be provided to a plurality of clients.

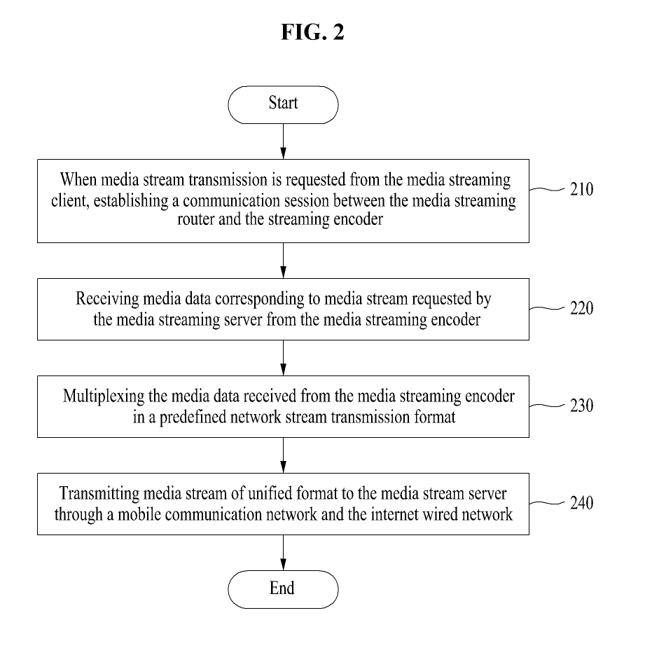

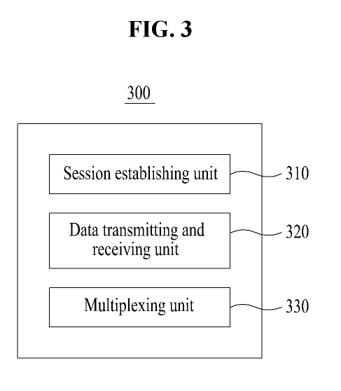

FIG. 2 is a flowchart illustrating a method for providing media streaming according to at least one example embodiment and FIG. 3 is a block diagram illustrating internal configuration of a system for providing media streaming according to at least one example embodiment.

In FIG. 3, a system for providing media streaming (300) may mean the media streaming router of FIG. 1 and include session establishing unit (310), data transmitting and receiving unit (320), and multiplexing unit (330). Also, each step (step 210 to step 240) of FIG. 2 may be performed by the session establishing unit (310), the data transmitting and receiving unit (320), and the multiplexing unit (330).

In step 210, when media stream transmission is requested from the media streaming client, a system for providing media stream, in other words, a communication session may be established between the media streaming router and the streaming encoder (110).

For example, the session establishing unit (310) may establish the media streaming encoder (110) and RTSP sessions for receiving media stream requested by the media stream server from the media streaming encoder (110). In addition, the session establishing unit (310) may establish communication session with the media streaming server (150) for transmitting the media stream received from the media streaming encoder. Also, the media streaming client (160) my establish communication session with the media streaming server (150) for being provided the media stream from the media streaming server (150). As such, in order that media stream encoded in the media streaming encoder is transmitted to the media streaming client, RTSP session may be established between the media streaming encoder, the system for providing media streaming, the media streaming server, and the media streaming client.

In step 220, the data transmitting and receiving unit (320) may be received media data corresponding to media stream requested by the media streaming server from the media streaming encoder. In this case, if there is a plurality of media streaming encoders, media streams of different network stream formats may be received.

For example, the data transmitting and receiving unit (320) may be received media data of different network stream formats such as media data shot by a network camera, media data shot by an IP camera, media data shot by an action cam, and the like from each media streaming encoder.

In step 230, the multiplexing unit (330) may multiplex the media data received from the media streaming encoder in a predefined network stream transmission format. For example, media data of the same format or media data of different formats may be received to the data transmitting and receiving unit (320). In this case, regardless of data format received from the media streaming encoder, for transmitting media stream to media streaming server through a mobile communication network, the multiplexing unit may multiplex the format of the received media data in predefined network stream transmission format. For example, the multiplexing unit (330) may convert the format of media data received from the media streaming encoder to MPEG-TS format.

In step 240, the data transmitting and receiving unit (320) may transmit media stream of unified format to the media stream server through a mobile communication network and an internet wired network. In this case, the data transmitting and receiving unit may transmit streaming of MPEG-TS to the media stream server over UDP.

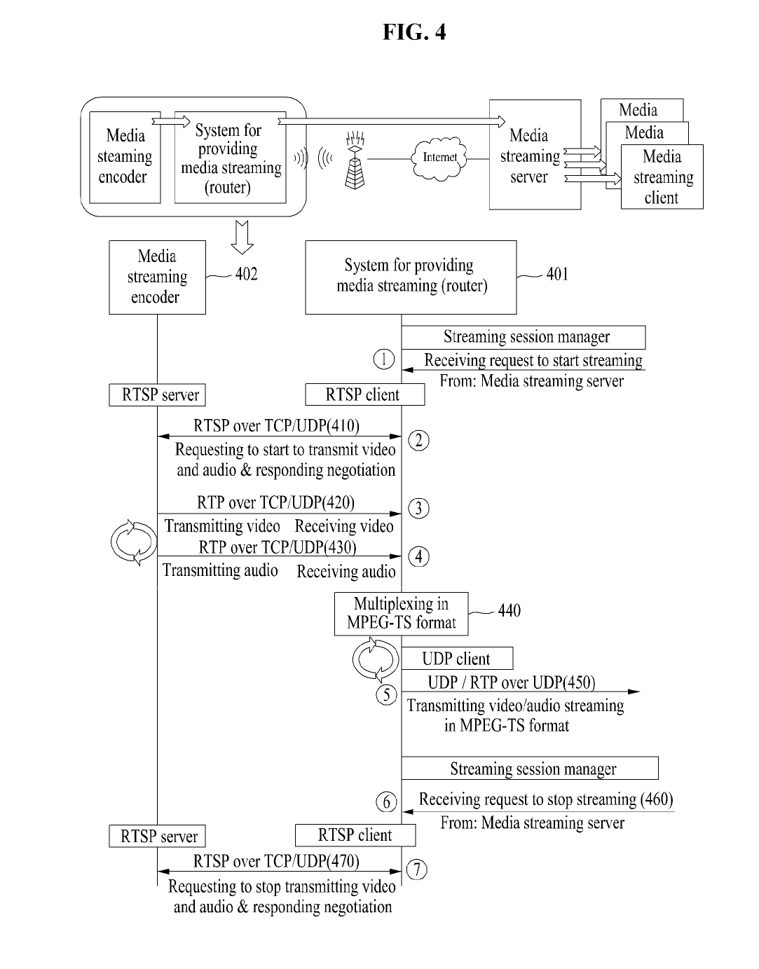

FIG. 4 illustrates communication flow for media stream transmission between a system for providing media stream and a media stream encoder according to at least one example embodiment.

In FIG. 4, a system for providing media streaming, that is, a case of transmitting media stream by establishing RTSP session between a streaming router and a media streaming encoder is described.

In FIG. 4, a system for providing media stream (401) may operate with RTSP client and media streaming encoder (402) may operate with RTSP server.

When receiving a message requesting to start transmitting media stream from the media streaming server, the data transmitting and receiving unit (320) may transmit a message requesting to start transmitting media data corresponding to the media stream to the media streaming encoder (402). In this case, the data transmitting and receiving unit (320) transmit a message requesting to start transmitting media stream (for example, recorded video and audio data) to the media streaming encoder (420) and may negotiate a process for transmitting the media stream (for example, recorded video and audio data) based on RTSP protocol (RTSP over TCP/UDP, 410).

When the negotiation is completed, the streaming encoder (402) may transmit a response message for the message requesting to start transmitting media stream to the system for providing media streaming.

After receiving the response message, the data transmitting and receiving unit (320) may receive media data corresponding to media stream requested by media stream server from the media streaming encoder (402). In this case, the video and audio data may be received in a form of RTP stream from the media streaming encoder (402). For example, video and audio data may be received through protocol stack of RTP over TPC or RTP over UDP (420, 430). In this case, audio data may be received after the video data is received first, or video data may be received after the audio data is received first.

The multiplexing unit (330) may multiplex media stream (i.e. video and audio data) received from the media streaming encoder (402) in a predefined MPEG-TS format for transmitting to the media streaming server through a mobile communication network (440).

Therefore, the data transmitting and receiving unit (320) may perform streaming transmission of media stream of the multiplexed MPEG-TS format to the media streaming server over UDP (User Datagram Protocol) (UDP/RTP over UDP, 450). In this case, the multiplexing unit (330) may multiplex media stream received from the media streaming encoder (402) unit until a message requesting to stop streaming is received from the media streaming server and the data transmitting and receiving unit (320) may perform streaming transmission of the multiplexed media stream to the media streaming server until the message requesting to stop is received.

In the case of receiving a message requesting to stop streaming from the media streaming server, the session establishing unit (310) may transmit a message requesting to stop media streaming to the media streaming encoder (402). In this case, the session establishing unit (310) transmits the message and may proceed with RTSP protocol negotiation to disable RTSP session establishment (RTSP over TCP/UDP, 470). For example, the session establishing unit (310) may transmit a message to disable RTSP session establishment to the encoder (402). Also, as receiving a response message for the message to disable session from the encoder (402), the RTSP session which is established between the encoder (402) and the system for providing media streaming (401) may be disabled. As the session is disabled in this way, the encoder (402) may stop transmitting media stream (video and audio data).

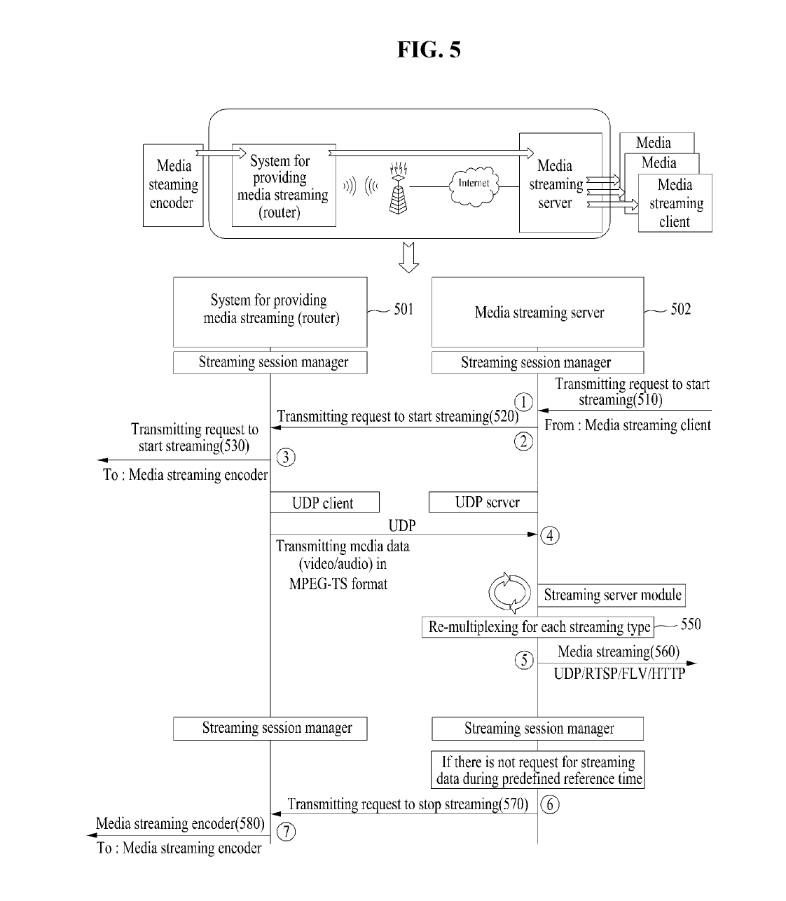

FIG. 5 illustrates communication flow for media stream transmission between a system for providing media stream and a media stream server according to at least one example embodiment.

Referring to FIG. 5, a system for providing media streaming (501) may receive a message requesting to start transmitting media stream from a media streaming server (502). For example, as a message requesting to start transmitting media stream is received from at least one media streaming client locally connected to the media streaming server (502) (510), the media streaming server (502) may transmit the message requesting to start transmitting to the system for providing media streaming (501) (520). Then, the system for providing media streaming (501) may transmit the message to the media streaming encoder (530).

Therefore, the system for providing media streaming system (501) may receive a respond message for the message and receive media data (i.e. video and audio data) from the media streaming encoder. Also, the system for media streaming (501) may multiplex the received media data format in MPEG-TS format and transmit the multiplexed media data to the media streaming server (502) over UDP.

The media streaming server (502) may re-multiplex the received media stream of MPEG-TS format according to a predetermined format and transmit media stream to the requesting media streaming client. For example, the media streaming server (502) may re-multiplex the media stream of MPEG-TS format in one of UDP, RTSP, FLV, and HTTP formats (550). In this case, if the formats established by the media streaming client are different from UDP, RTSP, FLV, and HTTP, the media streaming server (502) may re-multiplex media stream of MPEG-TS format in each 4 formats such as UDP, RTSP, FLV, and HTTP and transmit the re-multiplexed media stream of 4 formats to each corresponding media streaming client (560).

If there is not request to transmit media stream during predefined reference time from the media streaming client, the media streaming server (502) may transmit a message requesting to stop transmitting to the system for providing media streaming (501) (570). Then, the system for providing media streaming (501) received the message may transmit the message to the media streaming encoder.

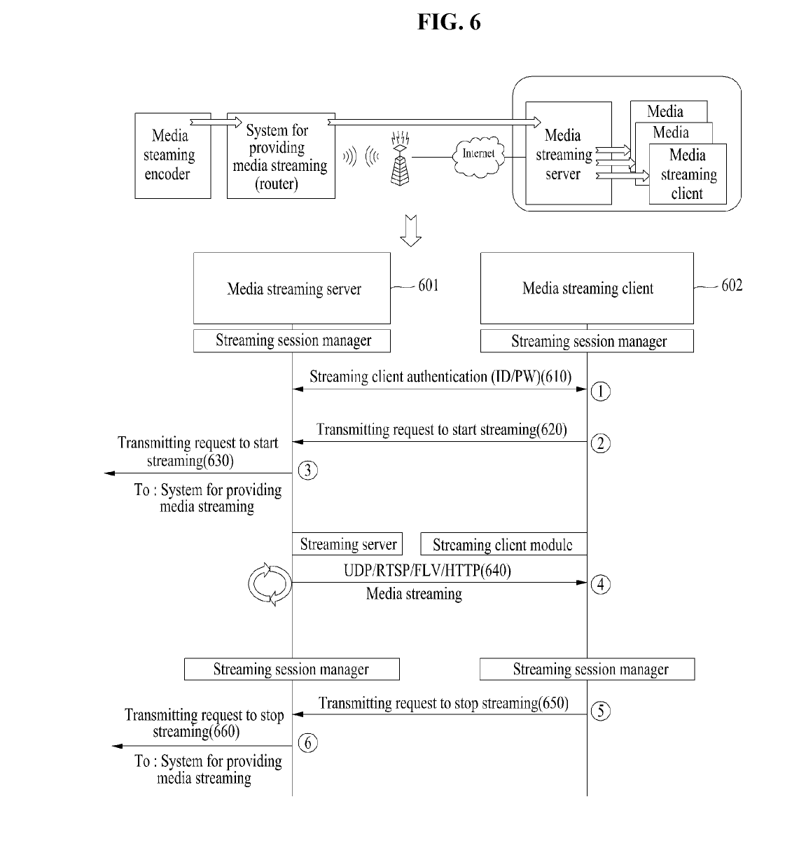

FIG. 6 illustrates communication flow for media stream transmission between a media stream server and a media streaming client according to at least one embodiment.

In FIG. 6, although one media streaming client is illustrated, this corresponds to an embodiments and the media streaming server may transmit media stream to two or more plurality of media streaming clients.

Referring to FIG. 6, a media streaming server (601) may provide media stream to a client who completed user authentication among a plurality of media streaming clients.

For example, a media streaming client (602) may be a member who signed up through a web page operated or managed by the streaming client (602) for being provided media stream service from a media streaming server (601). In other words, ID information and PW information which are identification information for identifying a client when signing up to be a member may be set and the media streaming client (602) may perform a user authentication by inputting the ID information and PW information on the web page which is provided by the media streaming client (602) for receiving desired media stream (610). Accordingly, the media streaming server (601) may store each ID information and PW information of a plurality of media streaming clients (602) in a pair.

After completing the user authentication, the media streaming server (601) may receive a message requesting to start transmitting media stream from the client (602). Then, the media streaming server (601) may transmit the message to the system for providing media stream.

As receiving a response message for the message, the media streaming server (601) may receive media stream requested by the client from the system for providing media streaming. For example, media stream of MPEG-TS format may be received. The media streaming server (601) may re-multiplex the media stream of MPEG-TS format in one of UDP, RTSP, FLV, and HTTP formats and provide the re-multiplexed media stream to corresponding client (602) (640).

Then, the client (602) may provide the received media stream by playing it on a screen to a user. For example, the media stream may be played through a player playing media stream. In this case, if display information such as a stop playback button, an icon, and the like on a player is selected by a user, the client (602) may transmit a message requesting to stop transmitting media stream to the media streaming server (601) (650). The media streaming sever (601) may transmit the message to the system for providing media streaming.

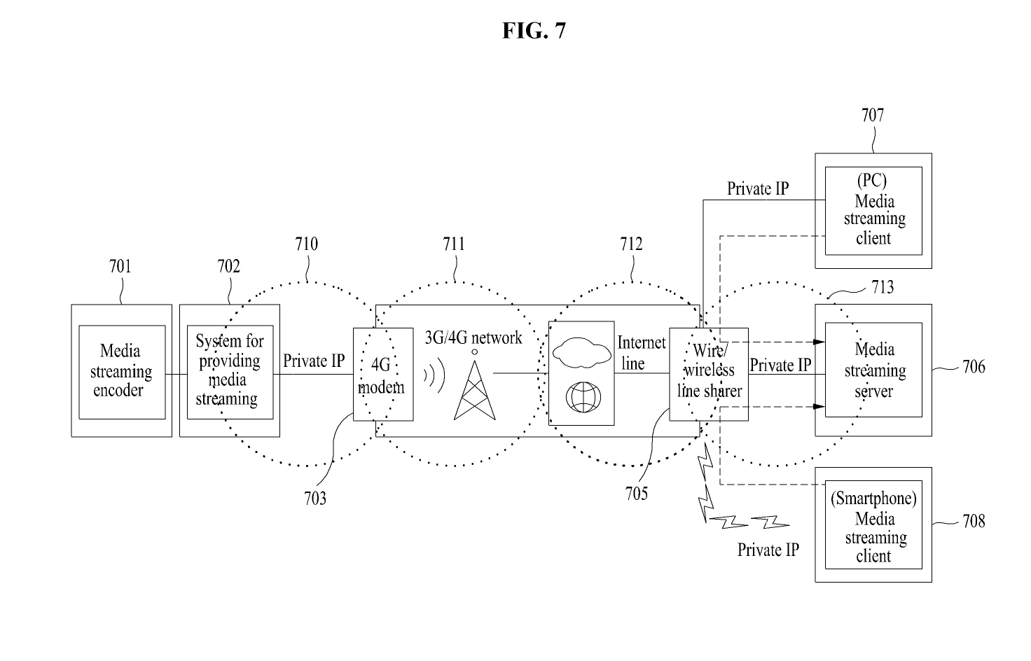

FIG. 7 is a block diagram illustrating a demonstration environment of an embedded media streaming package according to at least one example embodiment.

Referring to FIG. 7, a system for providing media streaming (702), in other words, a router may receive media data (i.e., video and audio data) from a encoder (701) and transmit it to a line sharer (705) connected to the internet wired network through 4G modem (703). In this case, the line sharer (705) may transmit the received media stream to a media stream server (706) connected to local network. DMZ (Demilitarized Zone) of the line sharer (705) is established to transmit all packets coming from outside to the media stream server (706) and local network of the line sharer (705) may be connected to a plurality of clients (707 and 708). For example, as clients playing RTSP media stream, a PC connected to the line sharer (705) through wired network, and a smart phone connected to Wi-Fi network may be used.

In FIG. 7, in order for a media stream to be provided from the encoder (701) to the client (708) through heterogeneous network, network setting between devices is required first.

Network setting (710) between the system for providing media streaming (702) and 4G modem (703) is described first. For example, the 4G modem (703), as a private IP (e.g., 192.168.5.1) DHCP (Dynamic Host Configuration Protocol) server, may assign an IP to the system for providing media streaming (702). For instance, the system for providing media streaming (702) may be assigned a private IP 19.168.5.xxx to DHCP from the 4G modem (703). Also, the system for providing media streaming (702) may set a private IP (e.g., 192.168.1.1) as an IP for communication with the media stream encoder (701). In addition, the media stream encoder (701) may set a private IP (e.g., 192.168.1.199) to as an IP for communication with the system for providing media streaming (702).

A network setting (711), as a network setting for using 4G network through 4G modem (703), may be assigned data communication IP from the corresponding mobile carrier to 4G network DHCP.

As a network setting (712) is a network setting for using the internet network, the line sharer (705) may be assigned IP from the corresponding internet wired network provider to internet wired network DHCP.

As a network setting (713) is a network setting between the line sharer (705) and the media streaming server (706), the line sharer (705) may assign IP to a PC client (707) and a smart phone client (708) as a private IP (e.g., 192.168.0.1) DHCP server. In this case, the line sharer (705) may set DMZ to transmit all packets received through the internet wired network to the media streaming server (706). Also, the media streaming server (706) may set a communication IP with a private IP (e.g., 192.168.0.201,) and the PC client (707) and the smart phone client (708) may set an IP assigned from the line share (705) as a communication IP. For example, the PC client (707) may be assigned an IP from the line sharer (705) with wired network private IP (192.168.0.xxx) DHCP and set it and the smartphone client (708) may be assigned IP from the line sharer (705) with wireless network private IP (192.168.0.xxx) and set it.

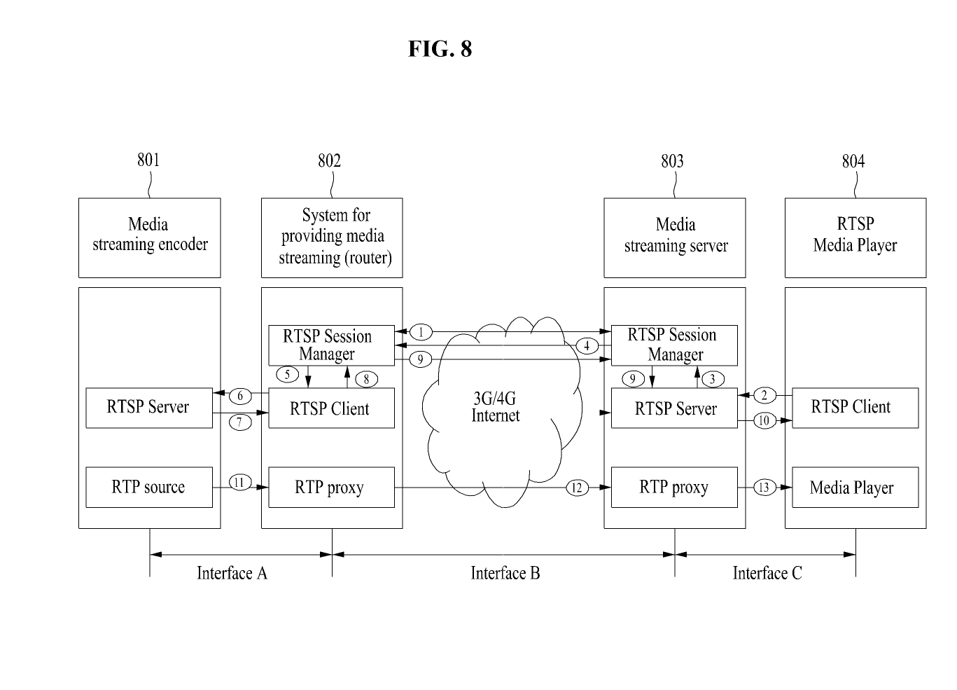

FIG. 8 illustrates a configuration of a module in accordance with RTSP media player drive between a system for providing media streaming and media streaming server according to at least one example embodiment.

In FIG. 8, environment setting of interface A, interface B, and interface C that exist for each network section may be as follows.

Interface A: As an interface supporting connection to inside of specific section in a private network environment, NAT (Network Address Translation) or Firewall may not be considered and in communication with a media streaming encoder (801) a system for providing media streaming (802) may open all network ports.

Interface B: A media streaming server (803) may be in a state of opening all ports relating RTP and waiting.

Interface C: As an interface supporting connection on the public internet or connection through private and internal network, if using a line sharer, RTSP media player (804) may exist behind the NAT.

In FIG. 8, \textcircled{1} to \textcircled{10} show a process that RTSP session is connected and \textcircled{11} to \textcircled{13} show a process that media data (video and audio data), i.e., RTP data is transmitted.

First, for RTSP session connection, a media streaming server (803) may open 60000^{th} TCP port and accept a connection request of a system for providing media streaming (802) (\textcircled{1}).

As an example, when requesting for connection with the media streaming server (803), the media streaming server (803) may transmit its unique ID “rserver” to the system for providing media streaming by using RTSP message. Then, the system for providing media streaming (802) may transmit a response message including its unique ID and unique ID of encoder connected to itself for the RTSP message to the media streaming server (803). For example, the system for providing media streaming (802) may transmit a response message which includes that its unique ID is “rrouter” and a unique ID of the media streaming encoder (801) connected to the system for providing media streaming (802) of ID rrouter is “ipcam” to the media streaming server (803).

Table 1 below shows operations to generate RTSP session by transmitting and receiving RTSP message between the system for media streaming (802) and the media streaming server (803).

TABLE 1

initializing rtsp relay with rserverd.conf
link connected from relay router (211.36.150.223:49314)
link create, fd = 6
link adding, fd = 6, type = 1
link updating, poll fd

| ------------------------------------------------------------------ | |
|---|---|
| \| TX | GET_LIST rtsp://* RTSP/1.0 |
| \| | User-Agent: rserver |
| \| | |
| ------------------------------------------------------------------ | |
| ------------------------------------------------------------------ | |
| \| RX | RTSP/1.0 200 OK |
| \| | Server: rrouter |
| \| | Alias: ipcam |

|
------------------------------------------------------------------

According to Table 1, a message (TX) which the media streaming server transmits to the system for providing media streaming (702) includes information indicating that its unique ID is “rserver” and a message which the system for providing media streaming (702) transmits to the media streaming server (803) includes information indicating that its unique ID is “rrouter” and a unique ID of connected encoder is “ipcam”, which may be confirmed.

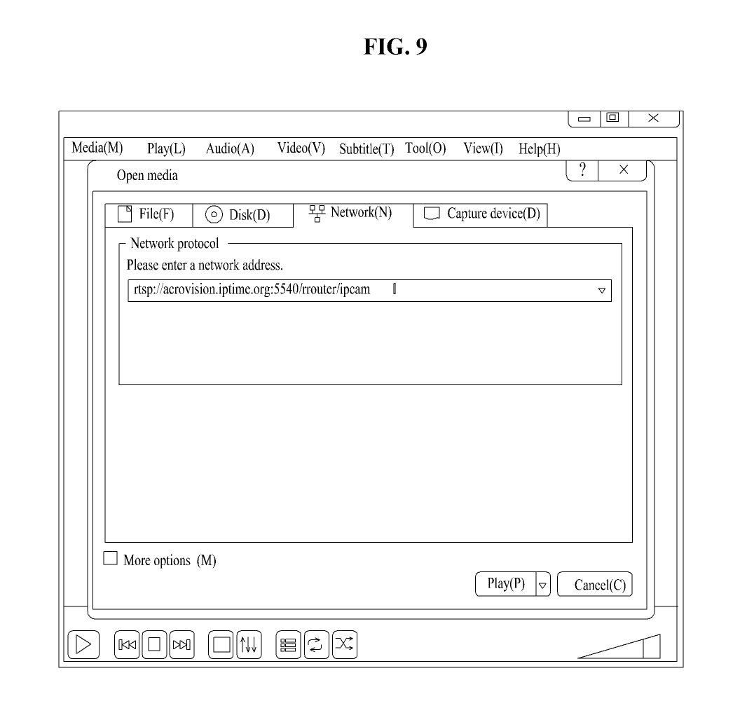

In FIG. 8, a process of \textcircled{2} may correspond to a process trying RTSP connection request from an RTSP media player (804) to the media streaming server (803). Referring to FIG. 9, it may be confirmed that Window 7 OS which is one of RTSP media players tries RTSP connection request to a VLC Player through the media streaming server (803).

Table 2 below may show a process accepting RTSP connection request from VLC Player which is an RTSP media player in the media streaming server (803) (\textcircled{3}).

TABLE 2
link connected from rtsp client (192.168.0.1:50902)
link create, fd = 7
link adding, fd = 7, type = 2
link updating, poll fd

| ------------------------------------------------------------------ | |
|---|---|
| \| RX | OPTIONS rtsp://acrovision.iptime.org:5540/rrouter/ipcam RTSP/1.0 |
| \| | CSeq: 2 |
| \| | User-Agent: LibVLC/2.1.5 (LIVE555 Streaming Media v2014.05.27) |

|
------------------------------------------------------------------

In FIG. 8, processes of \textcircled{4} to \textcircled{10} may be shown in Table 3 below.

TABLE 3
------------------------------------------------------------------

| | |
|---|---|
| \| TX | OPTIONS rtsp://rrouter/ipcam RTSP/1.0 |
| \| | CSeq: 2 |
| \| | User-Agent: rserver |

|
------------------------------------------------------------------
------------------------------------------------------------------

| | |
|---|---|
| \| RX | RTSP/1.0 200 OK |
| \| | CSeq: 2 |
| \| | Server: rrouter |
| \| | Public: OPTIONS, DESCRIBE, SETUP, PLAY, TEARDOWN, SET_PARAMETER |

|
------------------------------------------------------------------
------------------------------------------------------------------

| | |
|---|---|
| \| TX | RTSP/1.0 200 OK |
| \| | CSeq: 2 |
| \| | Server: rserver |
| \| | Public: OPTIONS, DESCRIBE, SETUP, PLAT, TEARDOWN, SET_PARAMETER |

|
------------------------------------------------------------------
------------------------------------------------------------------

| | |
|---|---|
| \| RX | DESCRIBE rtsp://acrovision.iptime.org:5540/rrouter/ipcam RTSP/1.0 |
| \| | CSeq: 3 |
| \| | User-Agent: LibVLC/2.1.5 (LIVE555 Streaming Media v2014.05.27) |
| \| | Accept: application/sdp |

|
------------------------------------------------------------------
------------------------------------------------------------------

| | |
|---|---|
| \| TX | DESCRIBE rtsp://rrouter/ipcam RTSP/1.0 |
| \| | CSeq: 3 |
| \| | User-Agent: rserver |
| \| | Accept: application/sdp |

|
------------------------------------------------------------------
------------------------------------------------------------------

| | |
|---|---|
| \| RX | RTSP/1.0 200 OK |
| \| | Cseq: 3 |
| \| | Server: rrouter |
| \| | Content-Type: application/sdp |
| \| | Content-length: 442 |
| \| | Content-Base: rtsp://rrouter/ipcam |
| \| | |
| \| | v=0 |
| \| | o=StreamingServer 3331435948 1116907222000 IN IP4 192.168.1.199 |
| \| | s=h264.mp4 |
| \| | c=IN IP4 0.0.0.0 |
| \| | t=0 0 |
| \| | a=control:* |
| \| | m=video 0 RTP/AVP 96 |
| \| | a=control:trackID=0 |
| \| | a=rtpmap:96 H264/90000 |
| \| | a=fmtp:96 packetization-mode=1; sprop-parameter-sets=Z00AH9oHgvsBagQEB |
| \| | m=audio 0 RTP/AVP 8 |
| \| | a=control:trackID=1 |
| \| | a=rtpmap:8 PCMA/8000 |
| \| | m=application 0 RTP/AVP 107 |
| \| | a=control:trackID=2 |
| \| | a=rtpmap:107 vnd.onvif.metadata/90000 |

|
------------------------------------------------------------------
------------------------------------------------------------------

| | |
|---|---|
| \| TX | RTSP/1.0 200 OK |
| \| | Cseq: 3 |
| \| | Server: rserver |
| \| | Content-Type: application/sdp |
| \| | Content-length: 442 |
| \| | Content-Base: rtsp://acrovision.iptime.org:5540/rrouter/ipcam |

|

| | |
|---|---|
| \| | v=0 |
| \| | o=StreamingServer 3331435948 1116907222000 IN IP4 192.168.1.199 |
| \| | s=h264.mp4 |
| \| | c=IN IP4 0.0.0.0 |
| \| | t=0 0 |
| \| | a=control:* |
| \| | m=video 0 RTP/AVP 96 |
| \| | a=control:trackID=0 |
| \| | a=rtpmap:96 H264/90000 |
| \| | a=fmtp:96 packetization-mode=1; sprop-parameter-sets=Z00AH9oHgvs1 |
| \| | m=audio 0 RTP/AVP 8 |
| \| | a=control:trackID=1 |
| \| | a=rtpmap:8 PCMA/8000 |
| \| | m=application 0 RTP/AVP 107 |
| \| | a=control:trackID=2 |
| \| | a=rtpmap:107 vnd.onvif.metadata/90000 |

|
------------------------------------------------------------------

In Table 3, it shows a process that RTSP message from the RTSP media player (804) to the media streaming encoder (801) retransmits request and response through the media streaming server (803) and the system for providing media streaming (802).

Table 4 below shows a process transmitting a message to open UDP port and wait for receiving media data to RTP from the media streaming encoder (801) through the media streaming server (803).

TABLE 4
------------------------------------------------------------------

| | |
|---|---|
| \| RX | SETUP rtsp://acrovision.iptime.org:5540/rrouter/ipcam/trackID=0 ] |
| \| | CSeq: 4 |
| \| | User-Agent: LibVLC/2.1.5 (LIVE555 Streaming Media v2014.05.27) |
| \| | Transport: RTP/AVP;unicast;client_port=61160-61161 |

|
------------------------------------------------------------------

According to Table 4, it may be confirmed that the RTSP media player (804) receives finally a message to open two UDP ports 61160 and 61161 and wait.

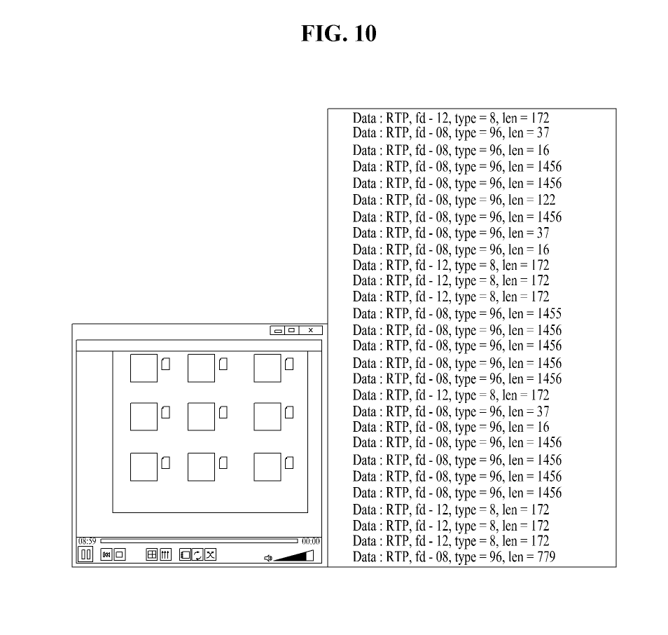

As a process transmitting RTP data, processes of \textcircled{11} to \textcircled{13} in FIG. 8 may be the same with FIG. 10. Referring to FIG. 10, it may be confirmed that the media streaming server (803) receives RTP data through the system for providing media streaming (802) and retransmits it to VLC which is the RTSP media player (804).

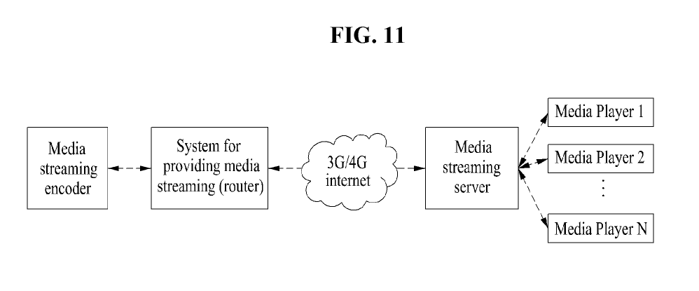

FIG. 11 illustrates a configuration expanded the number of client provided media stream according to at least one example embodiment.

Referring to FIG. 11, depending on hardware performance and network performance of the media streaming server, the number of clients (i.e., RTSP media player) may be increased as a provider wants.

Table 5 below may show request and response process of RTSP message for the media streaming server to share media stream of a current media player 1 with media player2, when one media player 1 receives media stream to RTP from the media streaming encoder through the media streaming server and another media player 2 wants to receive media stream of the same media streaming encoder.

TABLE 5
link connected from rtsp client (192.168.0.1:57149)
link create, fd = 16
link adding, fd = 16, type = 2
link updating, poll fd

| ------------------------------------------------------------------ | |
|---|---|
| \| RX | OPTIONS rtsp://acrovision.iptime.org:5540/rrouter/ipcam RTSP/1.0 |
| \| | CSeq: 2 |
| \| | User-Agent: LibVLC/2.2.0-pre1 (LIVE555 Streaming Media v2014.05.27) |

|
------------------------------------------------------------------

session creating, id = rtsp://acrovision.iptime.org:5540/rrouter/ipcam

| ------------------------------------------------------------------ | |
|---|---|
| \| TX | RTSP/1.0 200 OK |
| \| | CSeq: 2 |
| \| | Server: rserver |
| \| | Public: OPTIONS, DESCRIBE, SETUP, PLAY, TEARDOWN, SET_PARAMETER |
| \| | |
| ------------------------------------------------------------------ | |
| ------------------------------------------------------------------ | |
| \| RX | DESCRIBE rtsp://acrovision.iptime.org:5540/rrouter/ipcam RTSP/1.0 |
| \| | CSeq: 3 |
| \| | User-Agent: LibVLC/2.2.0-pre1 (LIVE555 Streaming Media v2014.05.27) |
| \| | Accept: application/sdp |
| \| | |
| ------------------------------------------------------------------ | |
| ------------------------------------------------------------------ | |
| \| TX | RTSP/1.0 200 OK |
| \| | Cseq: 3 |
| \| | Server: rserver |
| \| | Content-Type: application/sdp |
| \| | Content-length: 142 |
| \| | Content-Base: rtsp://acrovision.iptime.org:5540/rrouter/ipcam |
| \| | |
| \| | v=0 |
| \| | o=StreamingServer 3331435948 1116907222000 IN IP4 192.168.1.199 |
| \| | s=h264.mp4 |
| \| | c=IN IP4 0.0.0.0 |
| \| | t=0 0 |
| \| | a=control:* |
| \| | m=video 0 RTP/AVP 96 |
| \| | a=control:trackID=0 |
| \| | a=rtpmap:96 H264/90000 |
| \| | a=fmtp:96 packetization-mode=1; sprop-parameter-sets=Z00AH9oHgvs1 |
| \| | m=audio 0 RTP/AVP 8 |
| \| | a=control:trackID=1 |
| \| | a=rtpmap:8 PCMA/8000 |
| \| | m=application 0 RTP/AVP 107 |
| \| | a=control:trackID=2 |
| \| | a=rtpmap:107 vnd.onvif.metadata/90000 |

|
------------------------------------------------------------------

session adding stream sink, client_index = 1, stream_index = 1
stream socket created fd = 19 with 0.0.0.0:64814
stream socket created fd = 20 with 0.0.0.0:64815
session rtsp_session_connect
session retrieving port info, type = 0

| ------------------------------------------------------------------ | |
|---|---|
| \| TX | RTSP/1.0 200 OK |
| \| | CSeq: 5 |
| \| | Server: rserver |
| \| | Session: 65693745 |
| \| | Transport: RTP/AVP/UDP;unicast;client_port=35820-35821;server_pa |

|
------------------------------------------------------------------

session updating poll fd

| ------------------------------------------------------------------ | |
|---|---|
| \| RX | PLAY rtsp://acrovision.iptime.org:5540/rrouter/ipcam RTSP/1.0 |
| \| | CSeq: 6 |
| \| | User-Agent: LibVLC/2.2.0-pre1 (LIVE555 Streaming Media v2014.05 |
| \| | Session: 65693745 |
| \| | Range: npt=0.000- |
| \| | |
| ------------------------------------------------------------------ | |
| ------------------------------------------------------------------ | |
| \| TX | RTSP/1.0 200 OK |
| \| | CSeq: 6 |
| \| | Server: rserver |
| \| | Session: 65693745;timeout=120 |
| \| | Range: npt=0.000- |
| \| | RTP-Info: url=rtsp://192.168.1.199:32769/0/trackID=0;seq=417690. |

|
------------------------------------------------------------------

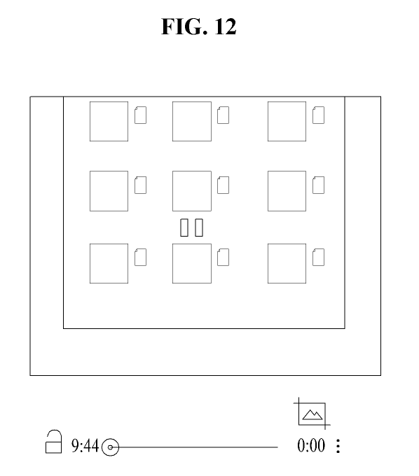

FIG. 12 illustrates a test result playing RTP data received from a media streaming server according to at least one example embodiment.

FIG. 12 is a test result that media stream is provided through the media streaming encoder, a system for providing media streaming, and the media streaming server by using VLC APP of Galaxy S5 with a media player 2. Referring to FIG. 12 and Table5, it may be confirmed that the media player 2 receives media stream (RTP data) which is the same with media stream played on a media player 1 of a PC and plays it.

The system and device described above may be implemented with hardware components, software components or a combination of hardware components and software components. For example, the device and components described in embodiments may be implemented with e.g., processors, controllers, ALU (Arithmetic Logic Unit), digital signal processors, micro computers, FPGA (Field Programmable Gate Array), PLU (Programmable Logic Unit), microprocessors, or such as any other devices executing and responding instructions by using one or more general purpose computers or special purpose computers. A processing device may execute OS (Operating System) and one or more applications executing on the OS. Also, the processing device may response to the execution of the software and access, store, manipulate, process, and generate data. For convenience of understanding, although a processing device is described as one being used, those skilled in the art may recognize that the processing device may include a plurality of processing elements and/or a plurality of type of processing elements. For example, the processing device may include a plurality of processors or one processor and one controller. Also, other processing configurations such as parallel processor are possible.

Software may include a computer program, a code, an instruction, or a combination of one or more of them and configure or command independently or collectively the processing device to operate as desired. Software and/or data may be embodied in any type of machines, components, physical devices, virtual equipment, computer storage mediums or device, or transmitted signal wave for being interpreted by the processing device or providing commands or data to the processing device. Software is distributed on a computer system connected with network and may be saved and executed in the distributed method. Software and data may be stored on one or more computer-readable mediums.

The methods according to the above-described exemplary embodiments of the inventive concept may be implemented with program instructions which may be executed through various computer means and may be recorded in computer-readable media. The media may also include, alone or in combination with the program instructions, data file, data structure, and the like. The program instructions recorded in the media may be designed and configured specially for the exemplary embodiments of the inventive concept or be known and available to those skilled in computer software. Computer-readable media include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like Program instructions include both machine code, such as produced by the computer using an interpreter. The described hardware devices may be configured to act as one or more software modules to perform the operations of the above-described exemplary embodiments of the incentive concept, or vice versa.

While a few exemplary embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned elements, such as systems, structures, devices, or circuits, are combined or coupled in different forms and modes than as described above or be substituted or switched with other components or equivalents.

Therefore, other implements, other embodiments, and equivalents to claims are within the scope of the following claims.

What is claimed is:

1. A method for providing media streaming by interworking Heterogeneous Network, comprising:
receiving media data corresponding to media stream requested by a media streaming server from a plurality of media streaming encoders;
multiplexing the received media data in a predefined transport stream format; and
performing streaming transport of the multiplexed media data to the media streaming server through a mobile communication network and an internet wired network,
wherein the media data have different transport stream formats for each of the plurality of media streaming encoders,
the receiving media data receives media data corresponding to a video encoded in the plurality of media streaming encoders installed on site at a request of the media streaming server, and
the multiplexing multiplexes media data corresponding to the different transport stream formats in the predefined transport stream format until a message requesting to stop streaming are received from the media streaming server based on RTSP (Real-Time Streaming Protocol) sessions established with the plurality of media streaming encoders.

2. The method as recited in claim 1, wherein the multiplexing multiplexes the media data of the different transport stream formats received from the media streaming encoders in an MPEG-TS (Moving Pictures Expert Group transport stream) format, and
the performing streaming transport performs streaming transport of the multiplexed MPEG-TS to the media streaming server over UDP (User Datagram Protocol).

3. The method as recited in claim 1, wherein the receiving media data comprises:
transmitting a message requesting to start transmitting of media data corresponding to the media stream to the media streaming encoders as a request to start transmitting of the media stream is received from the media streaming server; and
receiving a response message for the message requesting to start to transmitting of media data from the media streaming encoders.

4. The method as recited in claim 1, wherein the media streaming server is configured to re-multiplex media stream of transport stream format based on predetermined streaming type and to transmit the re-multiplexed media stream to at least one of media streaming clients.

5. The method as recited in claim 1, wherein the media stream transmitted from the media streaming encoders is simultaneously transmitted in stream form of UDP, RTSP, FLV (Flash Video), or HTTP (Hypertext Transfer Protocol) to a plurality of media streaming clients that has requested for transmission of the same media stream.

6. A system for providing media streaming by interworking heterogeneous network, comprising:
a data transmitting and receiving unit configured to receive media data corresponding to media stream requested by a media streaming server from a plurality of media streaming encoders; and
a multiplexing unit configured to multiplex the received media data in a predefined transport stream format, and
wherein the media data have different transport stream formats for each of the plurality of media streaming encoders,
the data transmitting and receiving unit receives media data corresponding to a video encoded in the plurality of media streaming encoders installed on site at a request of the media streaming server and performs streaming transport of the multiplexed media data to the media streaming server through a mobile communication network and internet wired network, and
the multiplexing unit multiplexes media data corresponding to the different transport stream formats in the predefined transport stream format until a message requesting to stop streaming is received from the media streaming server based on RTSP sessions established with the plurality of media streaming encoders.
